(19) United States
(12) Patent Application Publication
(10) Pub. No.: US 2005/0267972 A1
(43) Pub. Date: Dec. 1, 2005

(54) Lightweight remote display protocol

(75) Inventors: Jose Costa-Requena, Helsinki (FI); Vlad Stirbu, Tampere (FI); Remeres Jacobs, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/853,738

(22) Filed: May 25, 2004

(51) Int. Cl. G06F 15/16

(52) U.S. Cl. 709/227

(57) ABSTRACT

A light (resource-preserving) remote desktop protocol (32-35) for enabling a user of a client communication terminal (12) to interface with an application hosted by another communication terminal (14). Prior to exchanging remote user interfacing information according to the light remote desktop protocol, a discovery process (31) is performed. The light remote desktop protocol (32-35) provides for exchanging the user interfacing information according to a BEEP-like transport protocol and for indicating the user interfacing information itself using XML or SOAP to describe screens by which a user of the client makes inputs to the application and receives outputs from the application, and using a KPML-like or SOAP protocol derived from an input-event XML schema for the other communication terminal/remote user interfacing server (14) input events on the client communication terminal (12), including events in which a key is pressed on the client (12).

### TECHNICAL FIELD

The present invention pertains to the field of telecommunication. More particularly, the present invention pertains to a protocol by which a communication terminal—such as a cellular communication terminal but also possibly other kinds of communication terminals—is able to interface with an application hosted by other equipment via wireless or other telecommunication with the other equipment.

### BACKGROUND ART

The prior art provides for what is here called remote interfacing, in which a user of a mobile device interfaces with screens and dialog boxes communicated via a cellular communication network by an application hosted by other equipment, which could be but it not necessarily another mobile device.

For remote interfacing protocols—sometimes called remote UI (User Interface) sharing—the prior art provides several different candidates, such as RDP (Remote Desktop Protocol), VNC (Virtual Network Computing), and XRT (extensions for Real-Time market data). These candidates all require multiple TCP (Transmission Control Protocol) or connections/communication channels for exchanging screens and key events (including key events affecting the screens, such as when a user resizes the size of a remote UI sharing window). The requirement of multiple TCP connections in case of remote UI sharing by wireless communication terminals is disadvantageous.

What is needed is a protocol for remote UI sharing that is less demanding of wireless communication device resources.

### DISCLOSURE OF THE INVENTION

Accordingly, in a first aspect of the invention, a method is provided by which user interfacing information is exchanged between a client communication terminal and a server communication terminal to enable a user of the client to interact with an application hosted by the server, comprising: a discovery step, in which a remote user interfacing exchange protocol supported by both the client and the server or a gateway to the server is determined; and a remote interfacing step, in which the user interfacing information is exchanged according to a BEEP-like transport protocol for providing the user interfacing information.

In accord with the first aspect of the invention, the discovery step may include inspecting respective profile descriptions associated with the server or a gateway to the server or inspecting other messages provided by the server of a gateway to the server in response to a query regarding protocols supported by the server or gateway to the server.

Also in accord with the first aspect of the invention, the gateway may map the BEEP-like transport protocol to another protocol for use in exchanging the user interfacing information with the server.

Also in accord with the first aspect of the invention, the BEEP-like transport protocol may be a protocol using a single connection for data exchange. Further, the single connection may be a TCP connection or a UDP (User Datagram Protocol) connection. Also further, the single connection may comprise multiple data streams.

Also in accord with the first aspect of the invention, in the remote interfacing step, the remote user interfacing information may be indicated using a mark up language (e.g. XML or SOAP) to describe screens by which a user of the client makes inputs to the application and receives outputs from the application.

Also in accord with the first aspect of the invention, in the remote interfacing step, a mark up language (such as XML or SOAP) may be used to indicate to the server input events on the client including events in which a key is pressed on the client.

Also in accord with the first aspect of the invention, the remote user interfacing information may include information indicating screens by which a user of the client makes inputs to the application and receives outputs from the application, and in the remote interfacing step, the remote user interfacing information may be indicated according to an algorithm in which when a change is made to a screen, only the change is communicated in exchanging the user interfacing information (as opposed to e.g. the entire screen).

Also in accord with the first aspect of the invention, the discovery step may be performed according to a UPnP (Universal Plug'n'Play) or UPnP-like protocol over at least one segment of a communication path linking the client communication terminal to the server communication terminal.

Also in accord with the first aspect of the invention, the method may further comprise a step of authentication and confirming authorization in which at least the server communication terminal authenticates the client communication terminal and confirms that the client communication terminal is authorized to engage in a remote user interface sharing session.

Also in accord with the first aspect of the invention, the profile descriptions may be according to an XML schema and the remote user interfacing exchange protocol may be indicated in a UPNP <Protocol> description tag. Further, the parameters needed to set up the remote interfacing session may be provided in an optional <ProtocolInfo> tag.

In a second aspect of the invention, a computer program product is provided, comprising a computer readable storage structure embodying computer program code thereon for execution by a computer processor in a communication terminal, with said computer program code characterized in that it includes instructions for performing the steps of a method according to the first aspect of the invention.

In a third aspect of the invention, a communication terminal is provided, comprising: means for providing a profile description indicating support for a protocol for the exchange of user interfacing information with another communication terminal for enabling remote interfacing to an application hosted by the communication terminal or hosted by the other communication terminal; and means by which the user interfacing information is exchanged in a remote interfacing session according to a BEEP-like transport protocol for providing the user interfacing information.

In accord with the third aspect of the invention, the application may be hosted by the other communication terminal or the communication terminal may itself host the application. In either case, the communication terminal may be an element of an operator network forming part of a wireless communication network, or the communication terminal may instead be a mobile communication terminal. Also, the communication terminal may include equipment providing cellular communication functionality, or may include equipment providing short-range wireless communication functionality, or both.

In a fourth aspect of the invention, a system is provided, comprising a plurality of communication terminals according to the third aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of a client communication terminal interfacing with an application hosted by a remote server, according to the invention.

FIGS. 2A and 2B are protocol architecture diagrams illustrating the various protocols used in enabling the client communication terminal of FIG. 1 to interface with the remotely hosted application.

FIG. 3 is a flow chart illustrating remote user interfacing, i.e. illustrating a user of a client communication terminal interfacing with a remotely hosted application, according to the invention.

### DETAILED DESCRIPTION OF THE INVENTION

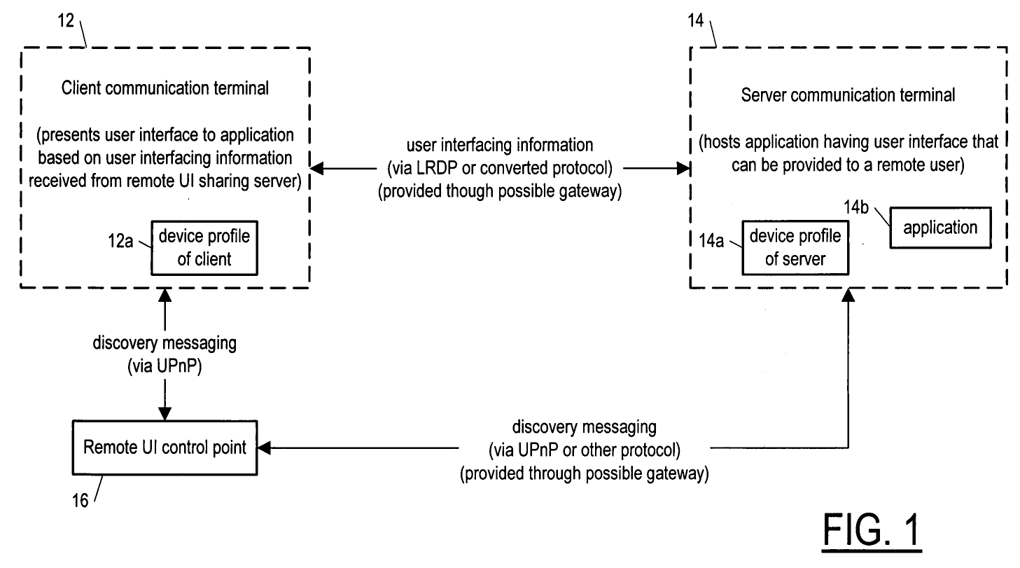

Referring now to FIG. 1, a client communication terminal 12 is shown exchanging with a server communication terminal 14 remote user interfacing information enabling a user of the client communication terminal to use an application hosted by the server communication terminal 14, in what is here called a remote UI sharing session. The remote UI sharing session is set up in a discovery process (according to the prior art and also according to the invention), and then the remote user interfacing information is exchanged according to a protocol provided by the invention—called here the light remote desktop protocol (LRDP) to stress its resource-preserving character—a protocol that uses as a transport protocol BEEP (Blocks Extensible Exchange Protocol) as set out in IETF (Internet Engineering Task Force) RFC (Request for Comments) 3080, or a BEEP-like protocol, and various markup languages to describe the information being communicated according to BEEP or the BEEP-like protocol, as described below, and is particularly advantageous in case of exchanging remote user interfacing information via cellular communication or other wireless communication (including short-range communication, such as according to Bluetooth). By a BEEP-like protocol is meant a protocol optimized for a wireless environment. More specifically, it should be one that at least uses a single data exchange connection/communication channel (a single TCP or UDP connection), i.e. a single transport channel connection. Further, is should use bandwidth efficiently, be resistant to errors in transmission, and allow using compressed formats for the data being exchanged. The actual remote user interfacing information is provided via such a protocol, but is expressed using e.g. XML (extensible Markup Language), as described elsewhere, and it is the actual remote user interfacing information that would be compressed. XML is set out in a specification provided by the WWW (World Wide Web) Consortium.

The communication path linking the client communication terminal 12 and the sever communication terminal 14 may include a radio access network (not shown, in order not to obscure the invention, i.e. for clarity) of a wireless communication network (such as a cellular communication network, but also other kinds of wireless communication network), and may possibly also include other elements of a wireless communication network and even elements of a wireline communication network to which the wireless communication network is coupled (none of which are shown, for clarity).

The server communication terminal 14 may be any kind of equipment able to communicate with the client communication terminal 12. Thus, e.g. the communication terminal 14 may even be a server connected to the Internet.

Still referring to FIG. 1, also shown is a remote UI control point, which is functionality needed for setting up a remote UI sharing session, functionality that can be hosted in equipment distinct from the client and server communication terminals 12 14, but can also be co-located with one or the other.

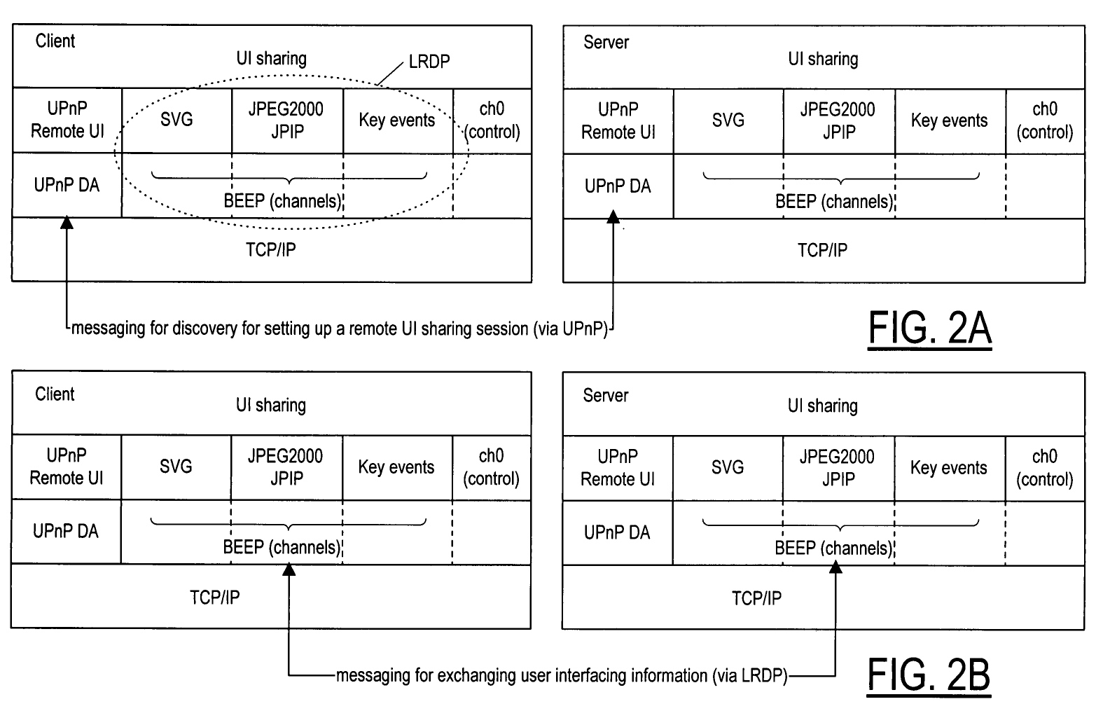

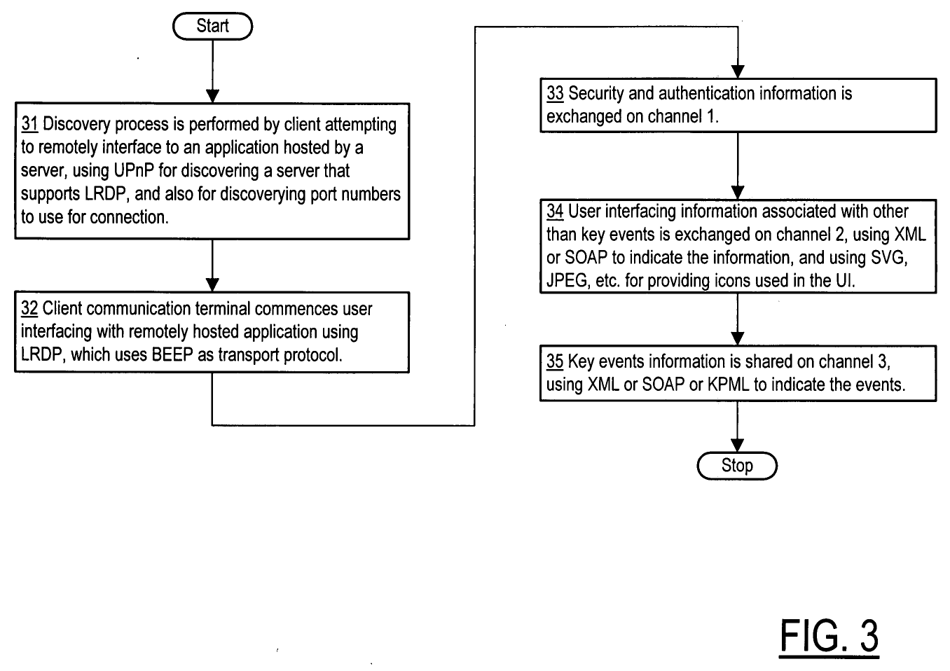

Referring now also to FIGS. 2A, 2B and 3, according to the invention, if a user of the client communication terminal 12 wants to execute an application hosted remotely, the user makes an input to the client communication terminal 12 causing it to perform a discovery process (step 31 of FIG. 3) (according to the prior art), a discovery process in which the remote UI control point 16 finds a host for the application the user wants to execute and confirms that the host supports the LRDP provided by the invention (as opposed to other possible remote desktop protocols, such as RDP, VNC, and XRT, mentioned above). The discovery process is preferably performed using UPnP—as do RDP, VNC, and XRT—or a protocol based on UPnP. (UPnP is set out in a specification provided by the UPnP Forum.) The process is as follows: the client communication terminal 12 either listens for announcements of services available in a network or else send a multicast SEARCH asking for services available in the network (a SEARCH to which nodes/communication terminals will respond with a service announcement). A service announcement indicates the services a node provides. The services can be to act as a source of media (files, video clips, etc.) and to act as a remote UI server (i.e. to provide remote user interfacing information allowing a user of the wireless communication terminal to interface with an application hosted by the node). An announcement also indicates the protocols a node supports for use in retrieving audio/video content in case the node is a source of media, or the protocols for exchanging the remote user interfacing information between the wireless communication terminal (which then becomes a remote UI client) and the node/remote UI server. Examples of the protocols for use in providing media are HTTP and RTSP. Examples of the protocols used for exchanging remote user interfacing information are LRDP (provided by the invention), RDP, VNC, and XRT. (Note that communication per UPnP is on a different communication channel/communication band than is used for communication per the other protocols.)

To confirm that a candidate host is suitable, the remote UI control point 16 examines the device profile of the candidate host (which it may obtain from a remote UI client by a GetDeviceProfile action, and from a remote UI server a GetCompatibleUIs action). According to the invention, both the client communication terminal 12 and the candidate host include in respective device profiles 13 15 the shortName LRDP inside the <protocol> tag of the DeviceProfile state variable. Additional parameters required to set up a remote UI sharing session can be included in the optional tag <protocolInfo>. An illustrative device profile according to the invention is as follows:

<?xml version=“1.0” encoding=“UTF-8”?>
<deviceprofile xmlns=“urn:schemas-upnp-org:remoteui:devprofile-1-0”
xmlns:xsi=“http://www.w3.org/2001/XMLSchema-instance”
xsi:schemaLocation=“urn:schemas-upnp-org:remoteui:devprofile-1-0
A_ARG_TYPE_DeviceProfile.xsd”>

<maxHoldUI>5</maxHoldUI>
<protocol shortName=“RDP”/>
<protocol shortName=“SyncML”/>
<protocol shortName=“LRDP”>

| | |
|---|---|
| <protocolInf a> | (opaque) . . .parameters for |
| | starting the BEEP |

session

</protocol Info>

</protocol>

</deviceProfile>

Note that the discovery step includes defining the ports to use for the remote UI sharing, and also an IP address where the client communication terminal/remote UI sharing client 12 can connect for starting the remote UI session.

In some embodiments, the remote UI control point confirms only that a candidate host is suitable (for acting as the remote UI sharing server 14) by determining that the candidate host supports at least one remote desktop protocol also supported by the client communication terminal 12, i.e. that at least some remote desktop protocols are common to both the candidate host and the client communication terminal 12. The client communication terminal 12 then selects which of the common protocols to use.

Following the discovery step, the client communication terminal 12 (remote UI sharing client) and the remote UI sharing server 14 communicate (in a next step 32) according to LRDP. In typical applications, previous to initiating any actual exchange of remote user interfacing information, handshaking (step 33) between the client and server is performed in order to authenticate and confirm authorization for the remote UI sharing.

The remote user interfacing information is then actually exchanged (steps 34 and 35) using LRDP, and so enabling the user of the client communication terminal 12 to execute the application hosted by the server communication terminal 14. The remote user interfacing information includes all information needed by the client communication terminal 12 to display the screens provided as part of the user interface, including screens indicating outputs by the application, and all inputs by the user to the application, including inputs that affect the screens, e.g. inputs that resize a screen. Thus, the remote user interfacing information can be characterized as including a UI description (i.e. having to do with the screens the user sees), and key event information (i.e. information indicating keys pressed by the user). As explained above, LRDP uses BEEP or a BEEP-like protocol as a transport protocol for creating multiple channels—i.e. multiple streams—and for exchanging the user interfacing information using e.g. one stream for exchanging key event information and another stream for exchanging the UI/screen information, whereas the user information itself is indicated using KPML (Keypad Markup Language) and XML or SOAP (Simple Object Access Protocol, as set out in a specification provided by the WWW Consortium, and in particular indicates SOAP version 1.2 or later) for key pressed information/events, and XML or XHTML (Extended Hypertext Markup Language) for other user interfacing information (which can include icons formatted in SVG or JPEG). KPML is used to describe key events according to the so-called Keypad Stimulus Protocol, and is set out in the IETF document: draft-ietf-sipping-kpml-02.txt. It is intended for transferring user inputs to a server (equipment hosting an application), i.e. for reporting the user key presses. However, KPML is useful for transferring only digit or DTMF signals, and so more capability for reporting key events may sometimes be needed. A protocol similar to KPML but extended as needed can be provided using an appropriate XML schema that specifically describes in XML format all key event information.

Note that, in contrast to RDP, XRT, and VNT, the invention uses only a single TCP connection and within that connection sets up multiple streams for exchanging event key information as one stream and screen information as another stream. Thus, the invention provides a more resource-preserving protocol.

The remoter user interfacing information is advantageously exchanged according to an algorithm that is efficient in what it communicates in exchanging the remote interfacing information. In particular, when a change is made to a screen, only the change is communicated in exchanging the user interfacing information. In some embodiments, LRDP functionality is included in the mobile software/architecture as an AIW (Application InterWorking) client API (application programming interface).

The invention is particularly advantageous for use in wireless communications, especially for use in mobile communication equipment, such as mobile cellular communication equipment, and also mobile or other communication equipment configured for short-range wireless communication (e.g. according to Bluetooth). In such equipment, the discovery process and remote user interfacing may be enabled by wireless communication, such as cellular communication (according to any of the different kinds of mobile communication network) or short-range wireless communication.

The invention also encompasses arrangements in which the use of the BEEP (or BEEP-like) protocol is not end-to-end, but is instead used only up to a gateway, where it is translated, or in other words mapped, into a protocol for use in exchanging the remote user interfacing information with the server. In such arrangements, the discovery process confirms that a suitable gateway/protocol converter is available (for converting BEEP to a protocol supported by one or another of the ends in the communication path and for also performing the inverse conversion) in the same way as in the case where there is no gateway, i.e. by e.g. UPnP (sending UPNP messages to see what services are available in the gateway, which then responds with a UPnP service description message). In other words, as in the case where there is no gateway, a profile description (in this case associated with the gateway/protocol converter) is examined to determine whether BEEP (or a BEEP-like protocol) is supported. In case of a gateway though, an entirely different protocol may be used by the gateway to determine what protocols are supported by the server, but the client/gateway interchange is unaffected by the use of such other protocols, and is not the subject of the invention.

The invention also encompasses even arrangements in which the use of BEEP (or a BEEP-like protocol) is end-to-end, but different discovery protocols are used on different segments of a server-gateway and gateway-client communication path.

It is important to understand that according to the principles of the invention in respect to a possible gateway/protocol converter, if a client communication terminal is attempting to interface with an application hosted by a relatively “dumb” device attached to a relatively more complex device via a link (e.g. a VCR connected to a PC via a USB), the complex device (e.g. the PC) is to perform the services of a gateway to the dumb device (the VCR). In fact, from the viewpoint of the client communication terminal, the complex device/gateway is the server communication terminal. In the example, the PC can even be thought of as a virtual VCR. Also in the example, UPnP can be used over at least the communication link between the client communication terminal (e.g. a mobile station) and the PC, and any other proprietary service discovery protocol can be used between the PC and the VCR (e.g. BTH Service Discovery Protocol or any other). Also, the PC would convert between BEEP and whatever protocol is used with the VCR.

It is important to understand that in case there is a gateway connecting the client to the server, the server may be distinct from the gateway (e.g. the server may be a VCR connected to a PC via short-range radiofrequency such as according to Bluetooth) or may be embedded in the gateway (such as software installed in a PC). In either case, though, all that the client sees, and all that the client needs to see, is the gateway, which stands in place of the server. Thus, how discovery works between the gateway and the server is irrelevant to the invention, as is how the remote user interfacing information is exchanged.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method by which user interfacing information is exchanged between a client communication terminal and a server communication terminal to enable a user of the client to interact with an application hosted by the server, comprising:
a discovery step, in which a remote user interfacing exchange protocol supported by both the client and the server or a gateway to the server is determined; and
a remote interfacing step, in which the user interfacing information is exchanged according to a BEEP-like transport protocol for providing the user interfacing information.

2. A method as in claim 1, wherein the discovery step includes inspecting respective profile descriptions associated with the server or a gateway to the server or inspecting other messages provided by the server of a gateway to the server in response to a query regarding protocols supported by the server or gateway to the server.

3. A method as in claim 1, wherein the gateway maps the BEEP-like transport protocol to another protocol for use in exchanging the user interfacing information with the server.

4. A method as in claim 1, wherein the BEEP-like transport protocol is a protocol using a single connection for data exchange.

5. A method as in claim 4, wherein the single connection is a TCP connection or a UDP connection.

6. A method as in claim 4, wherein the single connection comprises multiple data streams.

7. A method as in claim 1, wherein in the remote interfacing step, the remote user interfacing information is indicated using a mark up language to describe screens by which a user of the client makes inputs to the application and receives outputs from the application.

8. A method as in claim 7, wherein the mark up language is XML or an XML-like mark up language.

9. A method as in claim 7, wherein the mark up language is XML or SOAP.

10. A method as in claim 1, wherein in the remote interfacing step, a mark up language is used to indicate to the server input events on the client including events in which a key is pressed on the client.

11. A method as in claim 10, wherein the mark up language is XML or an XML-like mark up language.

12. A method as in claim 10, wherein the mark up language is KPML or SOAP.

13. A method as in claim 1, wherein the remote user interfacing information includes information indicating screens by which a user of the client makes inputs to the application and receives outputs from the application, and wherein in the remote interfacing step, the remote user interfacing information is indicated according to an algorithm in which when a change is made to a screen, only the change is communicated in exchanging the user interfacing information.

14. A method as in claim 1, wherein the discovery step is performed according to a UPnP-like protocol over at least one segment of a communication path linking the client communication terminal to the server communication terminal.

15. A method as in claim 1, further comprising a step of authentication and confirming authorization in which at least the server communication terminal authenticates the client communication terminal and confirms that the client communication terminal is authorized to engage in a remote user interface sharing session.

16. A method as in claim 15, wherein in the step of authentication and confirming authorization the client communication terminal authenticates the server communication terminal.

17. A method as in claim 1, wherein the profile descriptions are according to an XML schema and the remote user interfacing exchange protocol is indicated in a UPNP <Protocol> description tag.

18. A method as in claim 17, wherein the parameters needed to set up the remote interfacing session are provided in an optional <ProtocolInfo> tag.

19. A computer program product comprising: a computer readable storage structure embodying computer program code thereon for execution by a computer processor in a communication terminal, with said computer program code characterized in that it includes instructions for performing the steps of the method of claim 1.

20. A communication terminal, comprising:
means for providing a profile description indicating support for a protocol for the exchange of user interfacing information with another communication terminal for enabling remote interfacing to an application hosted by the communication terminal or hosted by the other communication terminal; and
means by which the user interfacing information is exchanged in a remote interfacing session according to a BEEP-like transport protocol for providing the user interfacing information.

21. A communication terminal as in claim 20, wherein the BEEP-like transport protocol is a protocol using a single connection for data exchange.

22. A communication terminal as in claim 20, wherein the remote user interfacing information is indicated using a mark up language to describe screens by which a user of the client makes inputs to the application and receives outputs from the application.

23. A communication terminal as in claim 22, wherein the mark up language is XML or an XML-like mark up language.

24. A communication terminal as in claim 22, wherein the mark up language is XML or SOAP.

25. A communication terminal as in claim 20, wherein the remote interfacing means uses a mark up language to communicate input events including events in which a key is pressed on the communication terminal or on the other communication terminal.

26. A communication terminal as in claim 25, wherein the mark up language is XML or an XML-like mark up language.

27. A communication terminal as in claim 25, wherein the mark up language is KPML or SOAP.

28. A communication terminal as in claim 20, wherein the means for indicating support for a protocol uses a UPnP-like protocol.

29. A communication terminal as in claim 20, wherein the profile descriptions are according to an XML schema and the protocol for the exchange of user interfacing information is indicated in a <protocol> tag.

30. A communication terminal as in claim 29, wherein the parameters needed to set up the remote interfacing session are provided in an optional <ProtocolInfo> tag.

31. A communication terminal as in claim 20, wherein the application is hosted by the other communication terminal.

32. A communication terminal as in claim 20, wherein the communication terminal hosts the application.

33. A communication terminal as in claim 20, wherein the communication terminal is an element of an operator network forming part of a wireless communication network.

34. A communication terminal as in claim 20, wherein the communication terminal is a mobile communication terminal.

35. A communication terminal as in claim 20, further comprising equipment providing cellular communication functionality.

36. A communication terminal as in claim 20, further comprising equipment providing short-range wireless communication functionality.

37. A communication terminal as in claim 20, further comprising means for authenticating another communication terminal.

38. A communication terminal as in claim 37, further comprising means for confirming authorization that another communication terminal is authorized to engage in a remote user interface sharing session.

39. A system, comprising a plurality of communication terminals according to claim 20.
